(19) United States
(12) Patent Application Publication
(10) Pub. No.: US 2021/0391607 A1
(43) Pub. Date: Dec. 16, 2021

(54) LITHIUM BATTERY MODULE WITH TEMPERATURE EQUALIZATION AND HEAT DISSIPATION STRUCTURE

(71) Applicant: AMITA TECHNOLOGIES INC., Taoyuan City (TW)

(72) Inventor: Yuan-Li CHIANG, Taoyuan City (TW)

(21) Appl. No.: 16/903,351

(22) Filed: Jun. 16, 2020

(51) Int. Cl. H01M 10/6551; H01M 10/0525; H01M 10/653

(52) U.S. Cl. CPC H01M 10/6551; H01M 10/653; H01M 10/0525

(57) ABSTRACT

A lithium battery module with temperature equalization and heat dissipation structure includes a battery cell and a metal housing. The battery cell includes a battery core and two electrode tabs. The metal housing includes a heat dissipation surface having a large area contacting to the battery core and a frame surrounded the heat dissipation surface. A buffer space recessed toward the battery cell is formed between the frame and the heat dissipation surface for providing a deformation space needed for the expansion of battery core, so as to maintain the overall appearance of the lithium battery and achieve the effect of heat dissipation.

### BACKGROUND OF THE INVENTION

### Field of the Invention

The present invention generally relates to a lithium battery, and more particular, to a lithium battery module with temperature equalization and heat dissipation structure.

### Description of Related Art

In lithium batteries, electrodes of battery cells and electrolyte are chemically reacted to generate electricity. Furthermore, during the processes of charging or discharging of a lithium battery, a large amount of heat is generated and the internal temperature is increased when electrolyte is ion-exchanged, which leads to a reduction of service life of battery cells and causes danger in use. In this regard, how to provide a temperature equalization and heat dissipation structure of the lithium battery to keep a stable working temperature of the battery core and hold the temperature evenly is the key to improve the service life and safety of the lithium battery module.

On the other hand, during each charge and discharge chemical reaction, trace of gas will be generated. While the accumulation of those gas, it will cause cells internal pressure rising, and that leads positive and negative electrodes of battery cells separated from the separation membrane, so that the performance and service life of the battery cells will decay dramatically and causes the deformation of the battery cell. As the deformation getting worse, eventually, the overall appearance of the electronic device with the battery cell module inside will be affected.

In view of the above drawbacks, the Inventor proposes the present invention based on his expert knowledge and elaborate researches in order to solve the problems of prior art.

### SUMMARY OF THE INVENTION

Accordingly, an object of the present invention is to provide a lithium battery module with temperature equalization and heat dissipation structure, so as to provide a deformation space required for the expansion and contraction of the electrode plates during the charging and discharging of the battery core; thus, the overall appearance of the lithium battery module can be maintained, and the effects of temperature equalization and heat dissipation can be achieved.

In order to achieve the object mentioned above, the present invention provides a lithium battery module with temperature equalization and heat dissipation structure comprising a battery cell and a metal housing. The battery cell includes a battery core and two electrode tabs. The metal housing includes a heat dissipation surface having a large area contacting the battery core and a frame surrounded the heat dissipation surface. A buffer space recessed toward the battery cell is formed between the frame and the heat dissipation surface.

Comparing to the prior art, the lithium battery module with temperature equalization and heat dissipation structure of the present invention has a metal housing covering the battery cell, and the metal housing has formed a buffer space recessed toward the battery cell between the frame and the heat dissipation surface. Thereby, when the battery core generates gas and the electrode plates (negative electrode and positive electrode) are expanded and contracted, they can expand to the buffer space. Because of the arrangement of the buffer space, the battery core and the electrode plates will not push the metal housing after expansion and contraction, and the electrode plates have a certain clamping force so that the overall appearance of the lithium battery module structure can be maintained. Furthermore, the lithium battery module can achieve effects of temperature equalization and heat dissipation structure through the metal housing having a large area attached to the battery core.

### BRIEF DESCRIPTION OF DRAWINGS

The features of the invention believed to be novel are set forth with particularity in the appended claims. The invention itself, however, may be best understood by reference to the following detailed description of the invention, which describes a number of exemplary embodiments of the invention, taken in conjunction with the accompanying drawings, in which:

FIG. 1 is a perspective schematic view of the lithium battery module of the present invention.

FIG. 2 is a perspective exploded view of the lithium battery module of the present invention.

FIG. 3 is a cross sectional view of the lithium battery module of the present invention.

FIG. 4 is a partial enlarged view of FIG. 3.

FIG. 5 is a cross sectional view of another embodiment of the lithium battery module of the present invention.

FIG. 6 is a partial enlarged view of FIG. 5.

### DETAILED DESCRIPTION OF THE PREFERRED EMBODIMENTS

In cooperation with attached drawings, the technical contents and detailed description of the invention are described thereinafter according to a number of preferable embodiments, not being used to limit its executing scope. Any equivalent variation or modification made according to appended claims is all covered by the claims claimed by the present invention.

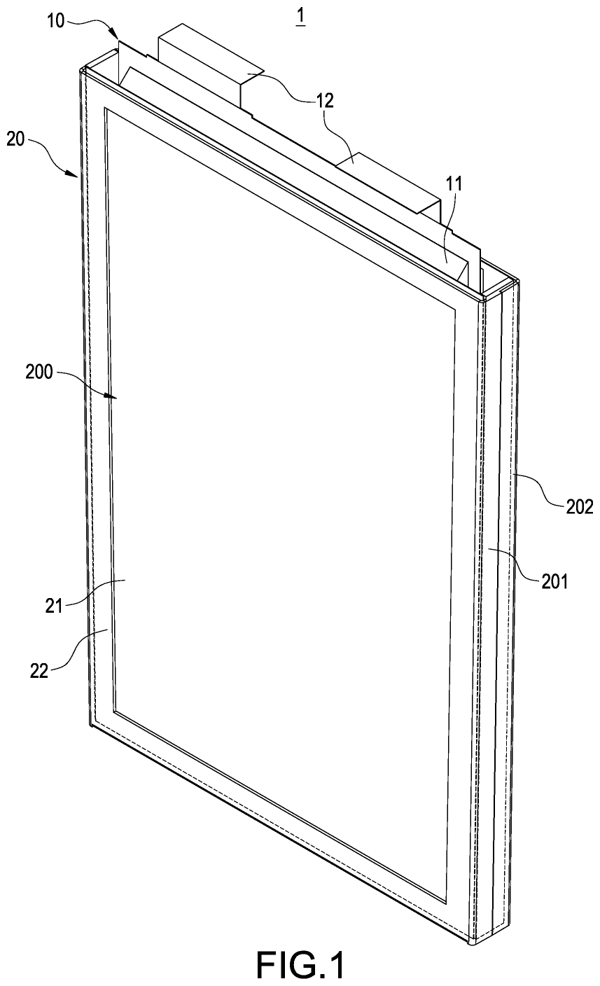

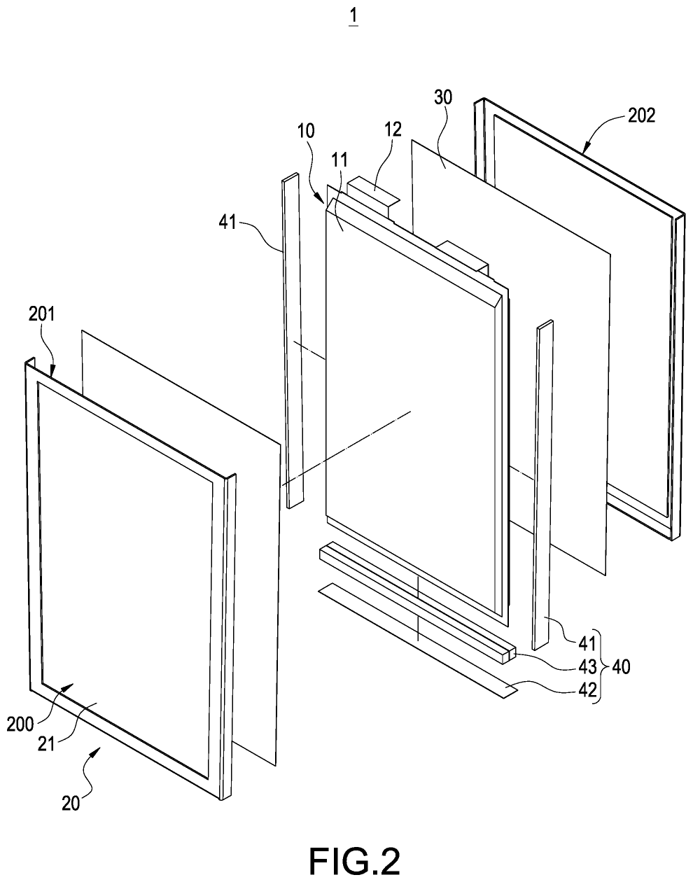

Please refer to FIG. 1 and FIG. 2, which depict a perspective schematic view of the lithium battery module of the present invention and a perspective exploded view of the lithium battery module of the present invention. The present invention is a lithium battery module 1 with temperature equalization and heat dissipation structure including a battery cell 10 and a metal housing 20. The metal housing 20 covers the battery cell 10 to constitute the lithium battery module 1. More detailed description of the lithium battery module 1 is as follows.

The battery cell 10 includes a battery core 11 and two electrode tabs 12, and the two electrode tabs 12 are protruded from a top side of the battery core 11. It should be noted that the battery cell 10 is an aluminum foil packaged battery cell, and its internal structure is not the main technical content of the present invention and will not be described here.

The metal housing 20 includes a heat dissipation surface 21 with a large area contacting the battery core 11 and a frame 22 surrounded the heat dissipation surface 21. Thereby, the heat generated by the battery core 11 can be dissipated through the attached metal housing 20 to achieve the effect of temperature equalization. In addition, a buffer space 200 recessed toward the battery cell is formed between the frame 22 and the heat dissipation surface 21.

In the present embodiment, the metal housing 20 has a first casing 201 and a second casing 202 opposite the first casing 201. Preferably, the metal housing 20 is an aluminum shell, but it is not restricted in actual implementation.

In the present embodiment, the lithium battery module 1 further includes a thermal conductive layer 30. The thermal conductive layer 30 is disposed between the metal housing 20 and the battery core 11. Preferably, the thermal conductive layer 30 is a thermal conductive material such as thermal conductive adhesive. In the present embodiment, a thermal conductive layer is disposed between the metal housing and two sides of the battery core 11 separately. In the present embodiment, the metal housing 20 and the battery core 11 are combined through the thermal conductive layer 30.

Moreover, the lithium battery module 1 further includes a plurality of buffer sheets 40. The buffer sheets 40 are disposed between the frame 22 of the metal housing 20 and the battery core 11.

Specifically, the buffer sheets 40 include a plurality of buffer side plates 41 and a buffer bottom plate 42. The buffer side plates 41 are located at two sides of the core battery 11, and the buffer bottom plate 42 is located at a bottom of the battery core 11. In addition, the buffer sheets 40 further include a plurality of buffer strips 43, and the buffer strips 43 are juxtaposed and arranged between the buffer bottom plate 42 and a bottom side of the battery core 11.

It should be noted that the lithium battery module 1 can make the battery core 11 to be firmly fixed in the metal housing 20 through the disposition of the buffer sheets 40.

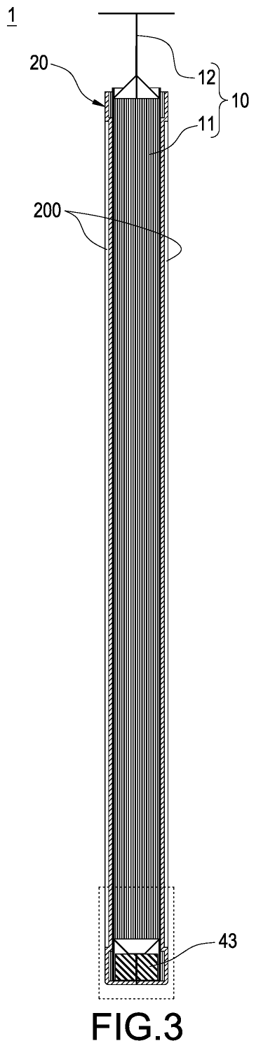

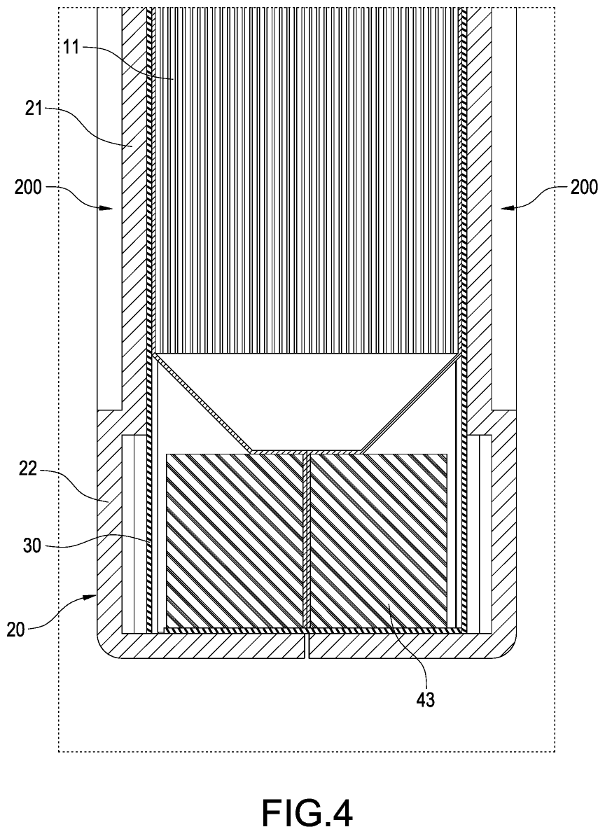

Please further refer to FIG. 3 and FIG. 4, which depict a cross sectional view of the lithium battery module of the present invention and a partial enlarged view of FIG. 3. Referring to FIG. 3, the two electrode tabs 12 are protruded between the first casing 201 and the second casing 202. In addition, referring to FIG. 4, a buffer space 200 recessed toward the battery cell 10 is formed between the frame 22 of the metal housing 20 and the heat dissipation surface 21. In more detail, the first casing 201 and the second casing 202 cover the battery core 11 and have a buffer space 200 separately. Thus, when the battery core 11 generates gas and the electrode tabs 12 are expanded and contracted, they can expand to the buffer space 200. Because of the arrangement of the buffer space 200, the battery core 11 and the electrode plates will not push the metal housing 20 after expansion and contraction, and the electrode plates have a certain clamping force so that the overall appearance of the lithium battery module 1 can be maintained. Moreover, the heat generated by the battery core 11 can be dissipated through the attached metal housing 20 to achieve the effect of temperature equalization and maintain a good heat dissipation.

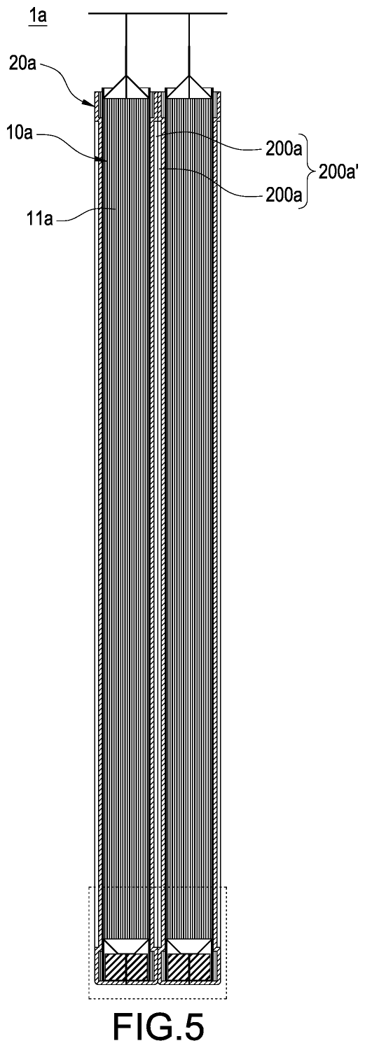

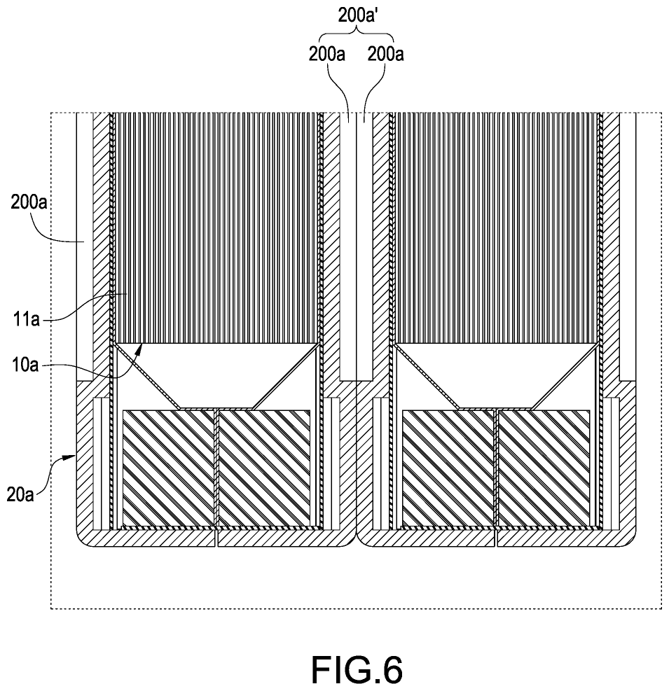

Please further refer to FIG. 5 and FIG. 6, which depict a cross sectional view of another embodiment of the lithium battery module of the present invention and a partial enlarged view of FIG. 5. As shown in FIG. 5, a quantity of the battery core 10a and the metal housing 20a of the lithium battery module 1a of the present invention is plural. The battery cells 10a are stacked with each other, and each metal housing 20a has a buffer space 200a between adjacent battery cores 11a. In addition, buffer spaces 200a of adjacent battery cores 11a are formed an expansion space 200a′ together to provide an expansion space 200a′ when the adjacent battery core 11a generates gas and expands. The disposition of the expansion space 200a′ can prevent the battery core 11a and the electrode plates from pushing the metal housings 20a after expansion and contraction, thereby the overall appearance of the lithium battery module 1a can be maintained.

It should be noted that, in the present embodiment, outer sides of the outermost metal housing 20a of the lithium battery module 1a have a buffer space 200a recessed toward the battery cell 10a separately. In actual implementation, the outermost battery cell 10a can provide with a metal housing 20a only at one side. That is, an outer surface of the outermost battery cell 10a does not have a buffer space 200a.

Although the present invention has been described with reference to the preferred embodiment thereof, it will be understood that the invention is not limited to the details thereof. Various substitutions and improvements have been suggested in the foregoing description, and others will occur to those of ordinary skill in the art. Therefore, all such substitutions and improvements are intended to be embraced within the scope of the invention as defined in the appended claims.

What is claimed is:

1. A lithium battery module with temperature equalization and heat dissipation structure, comprising:
a battery cell including a battery core and two electrode tabs; and
a metal housing including a heat dissipation surface contacting the battery core and a frame surrounded the heat dissipation surface, and a buffer space recessed toward the battery cell being formed between the frame and the heat dissipation surface.

2. The lithium battery module with temperature equalization and heat dissipation structure according to claim 1, wherein the metal housing has a first casing and a second casing opposite the first casing; the first casing and the second casing cover the battery core and have a buffer space separately; and the two electrode tabs are protruded between the first casing and the second casing.

3. The lithium battery module with temperature equalization and heat dissipation structure according to claim 1, further including a thermal conductive layer, wherein the thermal conductive layer is disposed between the metal housing and the battery core.

4. The lithium battery module with temperature equalization and heat dissipation structure according to claim 3, wherein the thermal conductive layer is a thermal conductive adhesive.

5. The lithium battery module with temperature equalization and heat dissipation structure according to claim 1, further including a plurality of buffer sheets, wherein the buffer sheets are disposed between the frame of the metal housings and the battery core.

6. The lithium battery module with temperature equalization and heat dissipation structure according to claim 5, wherein the buffer sheets include a plurality of buffer side plates and a buffer bottom plate; and the buffer side plates are located at two sides of the battery core, and the buffer bottom plate is located at a bottom of the battery core.

7. The lithium battery module with temperature equalization and heat dissipation structure according to claim 6, wherein the buffer sheets further include a plurality of buffer strips, and the buffer strips are juxtaposed and arranged between the buffer bottom plate and a bottom side of the battery core.

8. The lithium battery module with temperature equalization and heat dissipation structure according to claim 1, wherein the metal housing is an aluminum shell.

9. The lithium battery module with temperature equalization and heat dissipation structure according to claim 1, wherein a quantity of the battery cell and the metal casing is plural; and battery cells are stacked with each other, and each metal housing has a buffer space between adjacent battery cores, and buffer spaces of adjacent battery cores are formed an expansion space together.

10. The lithium battery module with temperature equalization and heat dissipation structure according to claim 9, wherein outer sides of the outermost metal housing have a buffer space recessed toward the battery cell separately.
